(19) United States
(12) Patent Application Publication
(10) Pub. No.: US 2026/0253058 A1
(43) Pub. Date: Aug. 27, 2026

(54) INFORMATION PROCESSING DEVICE, PROGRAM, AND INFORMATION PROCESSING METHOD

(71) Applicant: SUSHI TOP MARKETING, INC., Tokyo (JP)

(72) Inventors: Daisuke TOKUNAGA, Tokyo (JP); Daisuke OTSUKA, Tokyo (JP)

(73) Assignee: SUSHI TOP MARKETING, INC., Tokyo (JP)

(21) Appl. No.: 19/476,523

(22) PCT Filed: Apr. 19, 2024
(86) PCT No.: PCT/JP2024/015655

§ 371 Date: Oct. 17, 2025

(30) Foreign Application Priority Data
Apr. 20, 2023 (JP) 2023-069512
Jul. 28, 2023 (JP) 2023-123165

(51) Int. Cl. G06Q 20/36

(52) U.S. Cl. CPC G06Q 20/3672

(57) ABSTRACT

The present invention efficiently assists a user's acquisition of a token, and the like. Disclosed is an information processing device that, on the basis of various inputs from a user, automatically generates base information of a token that can be distributed on a network related to a blockchain composed of a plurality of computers.

### TECHNICAL FIELD

The present disclosure relates to an information processing device, program, and information processing method.

### BACKGROUND ART

Regarding token issuance methods and control methods managed on blockchain, Bitcoin has emerged as a system that can express and transfer value without electronic and centralized mechanisms, and blockchain technology that realizes this has spread widely. As understanding of Bitcoin concepts and blockchain technology has progressed, various coins that electronically express value other than Bitcoin have appeared. These valuable coins are referred to as tokens below. Due to the characteristics of blockchain technology, issued tokens have the characteristic of being extremely difficult to tamper with. Taking advantage of this characteristic, a usage method has spread that records holders of various electronic data such as images, videos, and audio on the blockchain to guarantee and prove ownership.

Tokens used for such purposes are called Non-Fungible Tokens (NFTs). While the concept of NFTs itself has existed for a long time, they began to gain recognition around 2017, and in 2021, some were traded at high prices, attracting attention. Specific usage methods for NFTs, such as intangible asset management (Patent Document 1) and contract/license management (Patent Document 2), are being considered. This enables providing characteristics of enhanced fault tolerance by transitioning from systems centrally managed by conventional rights holders to decentralized systems utilizing blockchain, and ensuring that recorded information can be used without problems even when central administrators cannot perform their duties.

### PRIOR ART DOCUMENTS

### Patent Documents

Patent Document 1: U.S. Pat. No. 6,640,320

Patent Document 2: JP 2020-68388 A

### SUMMARY OF THE INVENTION

### Problem to be Solved by the Invention

Currently, NFT technology itself is new, requiring expert knowledge for its creation, and there is a challenge that users find it difficult to acquire tokens like NFTs unless they understand blockchain transaction methods.

Therefore, the present disclosure aims to effectively support users' acquisition of tokens and the like.

### Means for Solving the Problem

According to one aspect of the present disclosure, an information processing device is provided that automatically generates base information for tokens that can circulate on a network related to blockchain composed of multiple computers, based on various inputs from users.

### Effects of the Invention

According to the present disclosure, it becomes possible to effectively support users' acquisition of tokens and the like.

### BRIEF DESCRIPTION OF THE DRAWINGS

FIG. 1 A diagram showing the basic configuration of this embodiment.

FIG. 2 A diagram showing the configuration of each node constituting the blockchain network, user terminals, and token control processing reception unit.

FIG. 3 A diagram showing token generation processing.

FIG. 4 A diagram showing token control information to be set in distribution means.

FIG. 5 A diagram showing the received data storage unit.

FIG. 6 A diagram showing token management information of smart contracts.

FIG. 7 A diagram showing token distribution number management.

FIG. 8 A flowchart for describing token receipt processing according to Embodiment 3.

FIG. 9 A diagram (Part 1) showing screen images for describing token receipt processing according to Embodiment 3.

FIG. 10 A diagram (Part 2) showing screen images for describing token receipt processing according to Embodiment 3.

FIG. 11 A diagram (Part 3) showing screen images for describing token receipt processing according to Embodiment 3.

FIG. 12 A diagram showing screen images when instructing to change the storage location of held tokens.

FIG. 13 A diagram showing screen images for describing token storage method options.

FIG. 14 A flowchart describing generative token creation according to Embodiment 4.

FIG. 15 A flowchart describing single token creation according to Embodiment 4.

FIG. 16 A diagram showing a list of token creation according to Embodiment 4.

FIG. 17A A diagram (Part 1) showing a screen for creating a single token.

FIG. 17B A diagram (Part 2) showing a screen for creating a single token.

FIG. 17C A diagram (Part 3) showing a screen for creating a single token.

FIG. 17D A diagram (Part 4) showing a screen for creating a single token.

FIG. 18A A diagram (Part 1) showing a screen for setting token issuance conditions.

FIG. 18B A diagram (Part 2) showing a screen for setting token issuance conditions.

FIG. 18C A diagram (Part 3) showing a screen for setting token issuance conditions.

FIG. 18D A diagram (Part 4) showing a screen for setting token issuance conditions.

FIG. 18E A diagram (Part 5) showing a screen for setting token issuance conditions.

FIG. 19A A diagram (Part 1) showing a screen for confirming set (input) token information.

FIG. 19B A diagram (Part 2) showing a screen for confirming set (input) token information.

FIG. 19C A diagram (Part 3) showing a screen for confirming set (input) token information.

FIG. 20 A diagram showing a screen for confirming URLs for distributing tokens.

FIG. 21A A diagram (Part 1) showing a screen displaying a list of created tokens.

FIG. 21B A diagram (Part 2) showing a screen displaying a list of created tokens.

FIG. 21C A diagram (Part 3) showing a screen displaying a list of created tokens.

FIG. 22A A diagram (Part 1) showing a screen displaying created tokens individually.

FIG. 22B A diagram (Part 2) showing a screen displaying created tokens individually.

FIG. 23A A diagram (Part 1) showing a screen displaying distribution history of created tokens.

FIG. 23B A diagram (Part 2) showing a screen displaying distribution history of created tokens.

FIG. 23C A diagram (Part 3) showing a screen displaying distribution history of created tokens.

FIG. 23D A diagram (Part 1) showing a screen displaying user management of created tokens.

FIG. 23E A diagram (Part 2) showing a screen displaying user management of created tokens.

FIG. 24 A diagram showing an example of a network diagram when wallet clustering using off-chain label information is performed.

FIG. 25 A diagram showing an example of similarity evaluation between wallet clusters (cosine similarity).

FIG. 26 A diagram showing an example of similarity evaluation between wallet clusters (co-occurrence count).

### MODE FOR CARRYING OUT THE INVENTION

Hereinafter, each embodiment will be described in detail with reference to the accompanying drawings.

### Embodiment 1

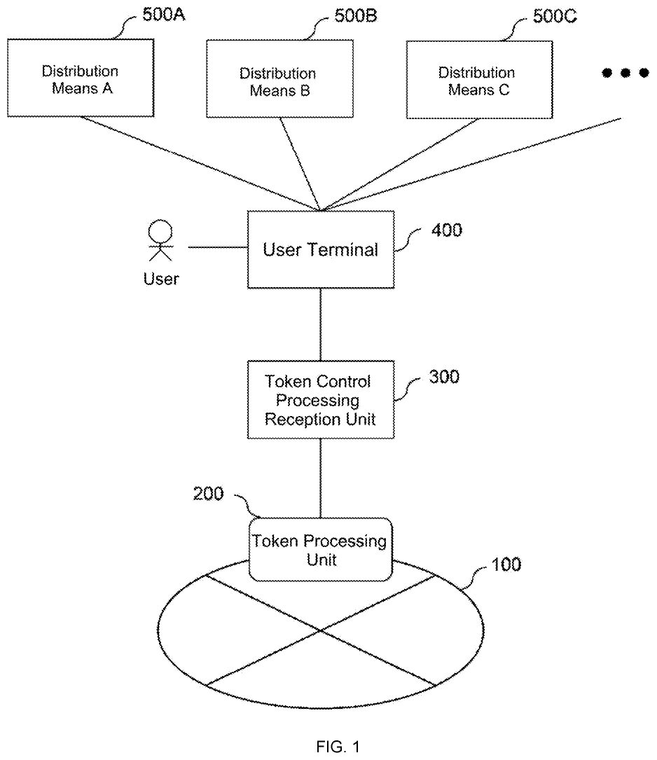

FIG. 1 is an overall configuration diagram of a system realizing Embodiment 1.

Blockchain network 100 is a P2P distributed network related to Ethereum, which is a network where many computers are connected to each other using P2P methods. Each connected computer is called a node. Each node records processing requests notified to blockchain network 100 from outside and executes processing according to processing requests from users. The results of processing according to processing requests can be recorded in storage managed by each node. One processing request can be transmitted distributively to each node using blockchain technology, enabling each node to execute the same processing for that processing request and record blockchain (distributed ledger). This enables processing that maintains identity information capable of tamper detection at each node even in a distributed environment (transactions where trust is guaranteed without third-party intervention). Processing related to execution on this blockchain is called smart contracts.

Here, smart contracts relate to program units (collections of program modules and associated data/information/computer programs) registered in blockchain network 100 and are executable by each node. Token processing unit 200 in this Embodiment 1 has functions related to smart contract processing and controls issuance of tokens (unique digital data that cannot be tampered with, created through the utilization of blockchain technology) according to requests from users.

In the following Embodiment 1, NFT (non-fungible token) issuance is described as an example of token types. NFTs in this Embodiment 1 are unique, non-replaceable unit data recorded on blockchain. They enable associating easily replicable items such as images, videos, audio, and other types of digital files as unique items.

In this Embodiment 1, blockchain network 100 is exemplified as an Ethereum-related network. However, this is merely illustrative and other types of networks may be used. As an example of standards that NFTs comply with, ERC721 (Ethereum Request for Comment 721) can be mentioned, but it is not limited to this.

Token control processing reception unit 300 is a server that communicates with blockchain network 100, receives requests from user terminals (information processing devices used by users) 400 such as smartphones and PCs, makes requests to token processing unit 200, and returns responses to user terminal 400.

Distribution means A to C (500A to 500C) provide users with information related to tokens (for example, part or all of token control information described later). Specifically, they provide various data in cooperation with user terminal 400, such as URL (Uniform Resource Locator), QR code, NFC (Near Field Communication), Bluetooth (registered trademark), audio, images, beacon information, location information, and external server behavior (for example, API (Application Programming Interface) information of SNS (Social Networking Service)).

When users directly communicate with blockchain network 100, software or hardware called wallets that manage tokens used in blockchain is utilized on user terminals. If wallet is already installed on user terminal 400, processing requests may be sent directly from user terminal 400 to token processing unit 200 without going through token control processing reception unit 300. In this Embodiment 1, assuming that many users do not possess wallets, examples are described where processing requests are made to token processing unit 200 using token control processing reception unit 300.

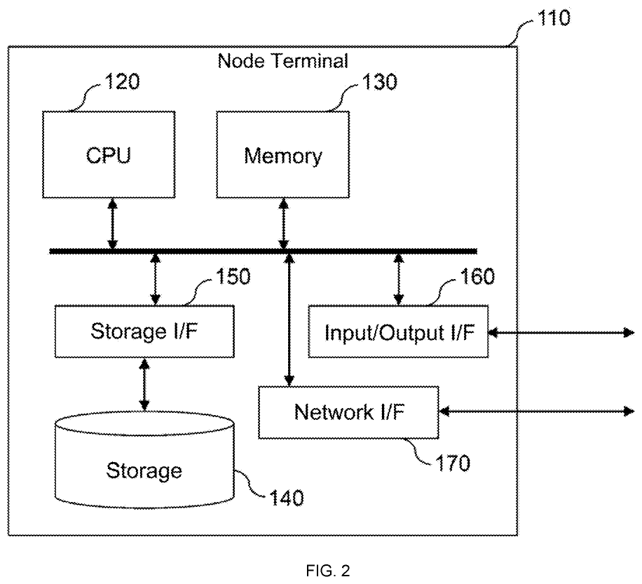

FIG. 2 is a configuration diagram regarding node terminal 110 that constructs blockchain network 100. Node terminal 110 may be an ordinary computer and may be composed of CPU 120, memory 130, storage 140, storage I/F 150 which is an interface for connecting storage, input/output I/F 160 for connecting external keyboards, mice, and displays, and network I/F 170 for connecting external computers and constructing networks.

Although not illustrated, semiconductor chips such as GPU and FPGA can be mounted on node terminal 110 as other processing units. In these functional units, for example, processing necessary for blockchain operation such as mining, which performs approval work when generating blocks for new token information to enable fraud checking, can be offloaded.

Storage 140 of node terminal 110 stores blockchain network information. For example, smart contract information is read from storage 140 to memory 130 and executed by CPU 120 (or GPU or FPGA in some cases). Token control processing reception unit 300 and user terminal 400 in this Embodiment 1 have the same configuration as node terminal 110 (equivalent to ordinary computers).

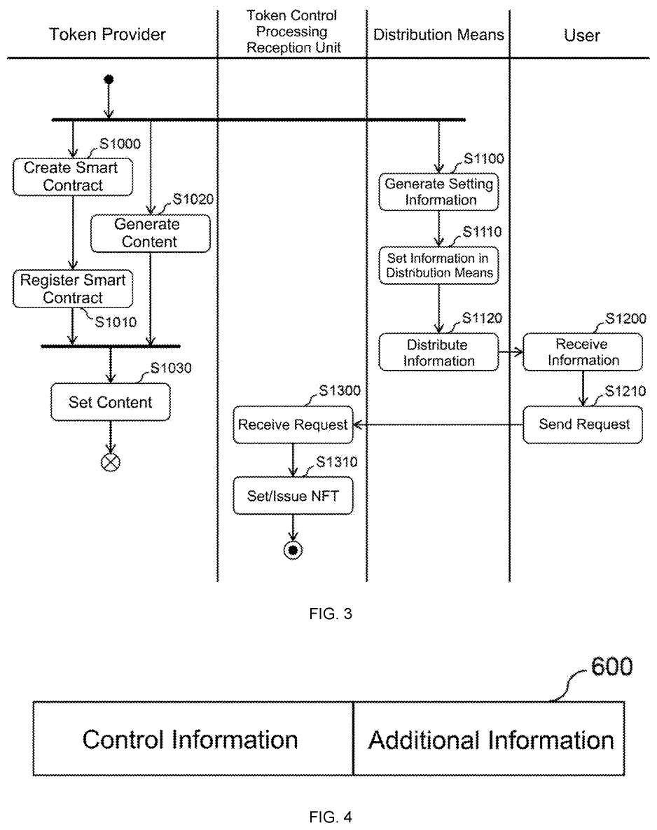

FIG. 3 shows processing procedures until users receive new NFTs (non-fungible tokens) and includes preparation parts for distributing NFTs to users (mechanisms for creating NFTs in advance or creating NFTs according to requests).

First, smart contract creation for computer protocols necessary for managing and operating NFTs is performed to provide NFTs and distribute NFTs (Step S1000). After confirming that the created smart contract has no bugs, token processing unit 200 related to the created smart contract is registered with blockchain network 100 (Step S1010. Blockchain network 100 and smart contracts are not illustrated in this flow).

In parallel, content related to NFT information reference is created and made registerable with token processing unit 200 related to smart contracts (Step S1020). Then, content settings are made to token processing unit 200 based on the ability to create content (Step S1030).

In this Embodiment 1, content settings are made after registering token processing unit 200 related to smart contracts with blockchain network 100, but rather than making content settings after registering token processing unit 200, there may be cases where registration proceeds after confirming content-related information during smart contract creation.

In this Embodiment 1, distribution means preparation is possible in parallel with smart contract and content development/creation. This is realized by setting information generation processing (Step S1100). Here, random numbers with sufficient range are used as setting information. For example, numerical values in the range of 2\hat{ }256 are assigned randomly. The wider the assignable range, the lower the possibility that generated random numbers match. Depending on distribution means, work such as printing and data writing to dedicated devices is necessary.

When trying to make one-to-one correspondence between information provided by distribution means such as QR codes and ID information managed by NFTs, it is necessary to wait for NFT development completion, but if certain preparations and rules such as site URLs to be accessed are established, distribution means can be freely generated using random numbers thereafter. This enables work to proceed independently of development and distribution means work to be implemented mechanically. Alternatively, rules may be defined to assign numerical ranges to each distribution means and assign serial numbers instead of random numbers.

For example, QR codes are assigned numbers from 1 to 10,000, and NFC from 10,001 to 20,000, such that all assigned are unique. Information generated this way is set in distribution means (Step S1110) and distributed to users (Step S1120). By separating development and distribution, advance sales can be realized, and collaboration with other products becomes easier.

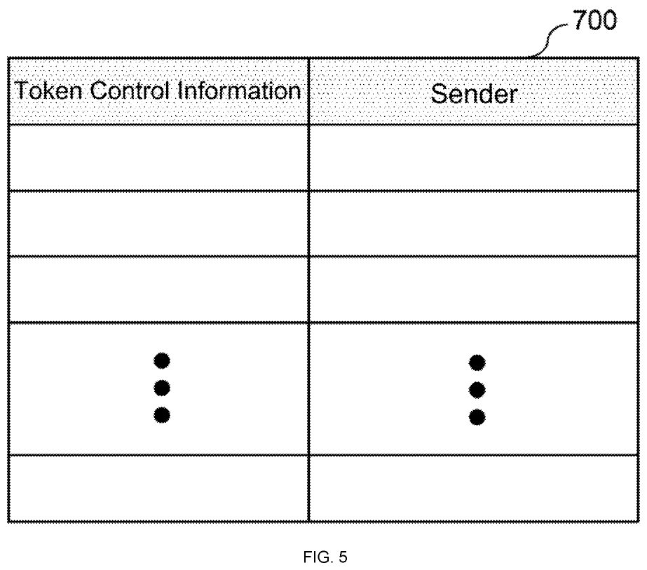

Token control information 600 shown in FIG. 4 is an information configuration provided from distribution means to user terminal 400. Here, random numbers used for NFT issuance or distribution, or predefined serial numbers are set as control information, and access destination URLs for NFT acquisition are stored as additional information. Additional information may include items other than access destination URLs. For example, distribution means types and management numbers, sales start dates and times, providing company URLs, etc.

Thus, for example, users receive printed QR codes as distribution means, read them with camera application on user terminals (smartphones, etc.) 400, and acquire access destination information and random numbers set for NFT exchange (Step S1200).

Next, users make requests for NFT output by notifying acquired access destinations of acquired random numbers (Step S1210). In this Embodiment 1, token control processing reception unit 300 is set as the access destination. Therefore, token control processing reception unit 300 receives requests from users (Step S1300).

When making requests from users, individual information (in public blockchains, this corresponds to user addresses. Hereinafter, this information is described as addresses) for identifying user terminal 400 making this request and enabling NFT receipt can also be transmitted.

FIG. 5 shows received data storage unit 700 where token control processing reception unit 300 stores received information. In the sender column (storage area), user addresses in blockchain network 100 are stored, but if necessary, user IP addresses may be stored to reliably specify individuals or individual user terminals 400 (for example, terminal identifiers). Also, if all or part of additional information in token control information 600 is unnecessary, these may be deleted before storing in the token control information 600 column (storage area) of received data storage unit 700.

When storing received data, token control processing reception unit 300 confirms whether there are items with the same token control information 600, and if already registered, notifies users that the distribution means content has been used and ends processing. Alternatively, when allowing the same user to possess multiple items such as “up to 3 per person,” it checks whether the number does not exceed the limit and ends processing if exceeded.

Upper limit checks for the number of users allowed to be available may be performed by token processing unit 200 related to smart contracts rather than token control processing reception unit 300. If checks are performed and no problems are found, received information is stored as is, and NFT (non-fungible token) issuance or settings are requested to token processing unit 200 using received information (Step S1310) (smart contracts are not illustrated in this flow).

Token control processing reception unit 300, which received NFT issuance or setting information from token processing unit 200, confirms that there are no defects in notification information related to user requests and changes the target NFT holder to the user. Alternatively, it newly issues NFTs and sets the holder as the user.

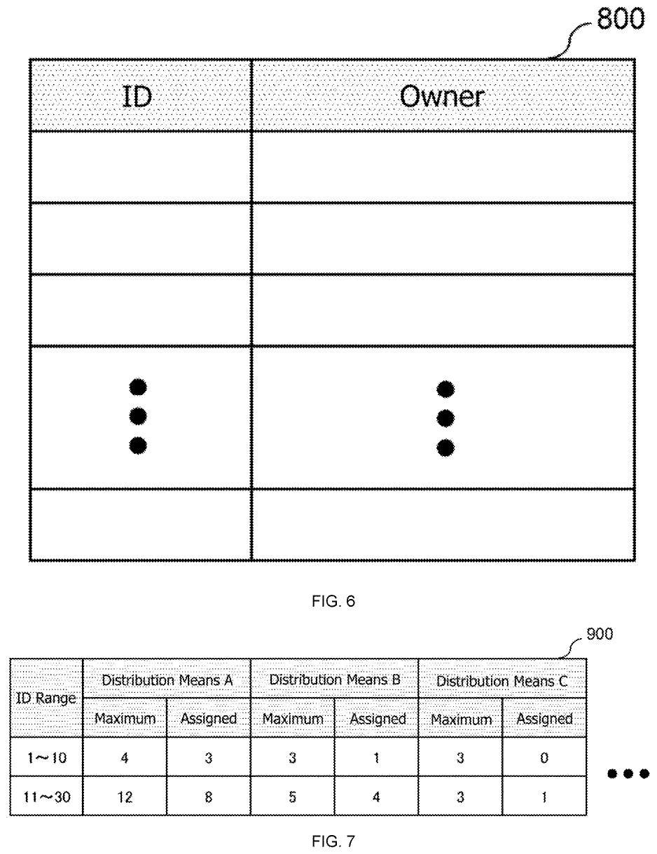

Token processing unit 200 related to smart contracts for managing and operating NFTs holds NFT ID and holder information as token management information 800. FIG. 6 shows an example of token management information 800 for smart contracts. The simplest method is to set notified random numbers or serial numbers directly as IDs and associate notified user addresses with those IDs for storage in token management information 800. While there are upper limit values for assignable IDs due to smart contract implementation constraints, this constraint can be avoided by considering this when defining information set in transmission information when assigning random numbers or serial numbers.

When NFTs have upper limits such as 100 or 10,000 pieces, one example corresponding to this is a method of finding remainders of received random numbers. For example, if distributing 100 NFTs, divide received random numbers by 100 and use the remainder as ID. Using remainders allows containing any notified value within a certain range. However, in this case, calculating remainders of random numbers notified later may result in the same value as used IDs. In this case, methods such as closed hashing that uses the next value of the calculated value as ID can be used. When assigning serial numbers with individual number upper limits anticipated, those values can be used directly as IDs.

Furthermore, efforts may be made to create scarcity by constraining NFT issuance numbers to reduce circulation numbers. In this Embodiment 1, this can be realized by limiting the number of individual items provided by distribution means.

Another realization method may express scarcity through ID ranges. For example, when there are 100 NFTs but NFTs numbered 1 to 10 have high value (associated with special content, etc.). This can also be realized using remainders, but when using closed hashing, situations may occur where “the remainder is 10 but shifts to 11, preventing acquisition of high-value NFTs.” In such cases, rather than simply using closed hashing, it can be handled by applying closed hashing within range from 1 to 10 when remainders become within this range.

However, since this Embodiment 1 assumes use of multiple distribution means, there is a possibility of distributing large quantities of high-value NFTs through certain distribution means. Since some distribution means may limit receivable users, distribution fairness must also be ensured. Token distribution number management 900 as shown in FIG. 7 may manage this. This is information for managing how many of which IDs are assigned to anticipated distribution means, and is used to manage maximum assignment numbers and actual assignment numbers after distribution starts. When assigning users in smart contracts, this information is also referenced to assign IDs. When the maximum number is assigned through certain distribution means and transmission information notified later has remainders in that range, which ID to assign is implemented in smart contracts by developers based on NFT concepts and operation rules. Here, only ID ranges are defined, but time constraints such as within 1 month or 3 months from sales start, statistical values for total reception numbers, or combined rules may be used.

This Embodiment 1 described cases of “acquiring NFTs using information obtained from any distribution mean.” In reality, there may be cases where multiple distribution means are used, such as NFT distribution information being provided through QR codes and broadcast audio at the same location. In such cases, applications such as distributing NFTs only when token distribution information from multiple distribution means is sent, or distributing special NFTs when multiple distribution means are used, can be considered. By combining multiple distribution means this way, location and time-based NFT distribution can be realized without adding additional information to transmission information and additional information, and can also serve as some security measures such as “not distributing with just QR codes.”

This example described assuming “NFT issuance” processing, but not only issuance but also processing implementation for tokens including NFTs on blockchain network 100 can be realized with this mechanism. For example, it can be utilized when building services where NFTs used in games have “parameters improved by going to certain locations at specific dates and times,” linking real world and NFT information.

This Embodiment 1 described configurations where users request processing to token processing unit 200 via token control processing reception unit 300, but when wallets become commonly installed on user terminals 400, users will likely directly notify token processing unit 200 of token control information 600 and request processing. In this case, this Embodiment 1 can be realized by managing received data storage unit 700, which is managed by the token control processing reception unit 300, in the token processing unit 200 which is a smart contract.

### Embodiment 2

Using the method of Embodiment 1 described above, distribution information can be created independently of content creation, and tokens such as NFTs can be distributed to users in advance through various distribution means. However, when simply using distribution means for individual number limits or high-value token distribution, there are risks of abuse. For example, considering QR code usage, anyone can receive QR code information itself and easily confirm its contents.

That is, users can easily know information such as access destination URLs and random numbers or serial numbers used for ID assignment. Also, since QR code creation tools are publicly available on the web, users can process original information on their side after receiving QR codes and request processing to token control processing reception unit 300. This creates two major problems: “users can acquire tokens with desired IDs” and “users can acquire unlimited tokens without obtaining information from distribution means.”

For “arbitrary ID token acquisition possibility,” this can be handled by processing random numbers on the receiving side. When token control processing reception unit 300 receives requests from users (Step S1300), it generates random numbers, combines them (such as XOR) to create new information, and uses this as ID assignment information. Instead of random number generation, hash values may be obtained from salt (arbitrary variable information) and notified information for use as assignment information. This problem can be handled by not using information notified from users directly.

Here, examples of creating and combining random numbers or creating hash values at token control processing reception unit 300 were described, but similar processing may be implemented in smart contract-related processing. Normally, random numbers cannot be generated in smart contract-related processing, but there is a mechanism called oracles that provides reliable information from outside. Using this, random numbers can be acquired for use in smart contract-related processing. Since token control processing reception unit 300 is often under token provider management, implementing in smart contract-related processing to publish information on blockchain network 100 visible to users and present fairness is possible.

The latter issue of “users being able to acquire arbitrary numbers of tokens” is a larger problem. When holding only blockchain network 100 address information as sender information, users can freely create multiple addresses, making individual number limits non-functional as constraints. One method for this problem is collecting user information such as names, addresses, and email addresses when receiving token control information 600 from distribution means, and having users input user information when using token control information 600. However, distribution means such as QR codes and NFC alone cannot acquire detailed user information, requiring separate systems and making operations cumbersome. Also, users are forced to work, and some people may feel they are unnecessarily providing personal information, creating issues where tokens may not be received.

Therefore, this Embodiment 2 handles this problem by encrypting token control information 600 transmitted by distribution means. The procedures are the same as FIG. 3, but some processing is added. This content is described below.

First, cryptographic keys are prepared to encrypt control information stored in token control information 600. Here, cases using public key cryptography (encryption methods using different keys for encryption and decryption, with encryption keys being publicly available) are described, but the same applies when using common key cryptography such as AES.

First, token providers create public keys before implementing token creation. Private keys are managed by token providers and set in token control processing reception unit 300 in safely usable forms, and public keys paired with private keys are provided to setters performing information setting work for distribution means. In distribution means, control information is encrypted when generating random numbers or serial numbers using public keys made settable by receiving from token providers (Step S1100).

Additional information in token control information 600 stores information such as access destination URLs, so it stores information in plaintext available to users when acquiring information. For processing, if there is other information to be concealed, those parts may also be encrypted and stored. Also, public keys for encryption are used only by setters who set token control information 600 in distribution means and must not be published to other workers or externally. Subsequent processing follows FIG. 3, but the following processing is added, specifically, token control processing reception unit 300, which received encrypted token control information 600 sent based on user requests in Step S1300, decrypts encrypted token control information 600 using private keys paired with public keys, and implements subsequent processing by acquiring control information related to NFT issuance requests and random numbers (information configuration provided from distribution means to user terminal 400) obtained based on this decryption.

Also, to enable decryption at token control processing reception unit 300, encrypted data and additional information (information from user side) may be stored and managed in received data storage unit 700. For example, after token control processing reception unit 300 receives encrypted transmission information requesting NFT issuance or settings to token processing unit 200 related to smart contracts (Step S1310), token processing unit 200 that received this may be enabled to decrypt received encrypted control information using private keys stored in received data storage unit 700. Thus, when performing smart contract-related processing, private key information can be registered in received data storage unit 700 to safely use encrypted token control information 600. The opposite way of holding public and private key pairs may also be enabled. Also, smart contracts may be enabled to decrypt with registered key information but not encrypt.

When encrypting token control information 600 using public keys, by building mechanisms that do not disclose private key information necessary for decryption to distribution means or users, the technical characteristics of public key cryptography make deriving public keys from private keys easy, but deriving private keys from public keys requires enormous calculation time, making it practically impossible. Therefore, users can be prevented from freely changing token control information 600, solving the problem of “users being able to acquire arbitrary numbers of tokens.”

The above described methods of managing private keys at token control processing reception unit 300. However, programs such as JavaScript (registered trademark) in pages provided by token control processing reception unit 300 may generate key pairs and execute processing to store and manage them in browser local storage. Also, token processing unit 200 is publicly available to those accessing blockchain network 100. Therefore, as a modification, token processing unit 200 may also enable encryption processing related to NFT issuance or setting information based on smart contract-related processing using public key cryptography or the like.

### Embodiment 3

When users receive tokens such as NFTs, information uniquely identifying users in blockchain network 100 is necessary. In public blockchains such as Ethereum, addresses generated from public keys of key pairs managed by users correspond to this. However, possessing addresses requires wallets or other applications or hardware for managing underlying key pairs, making it difficult for general users. Therefore, this example describes methods for solving this problem.

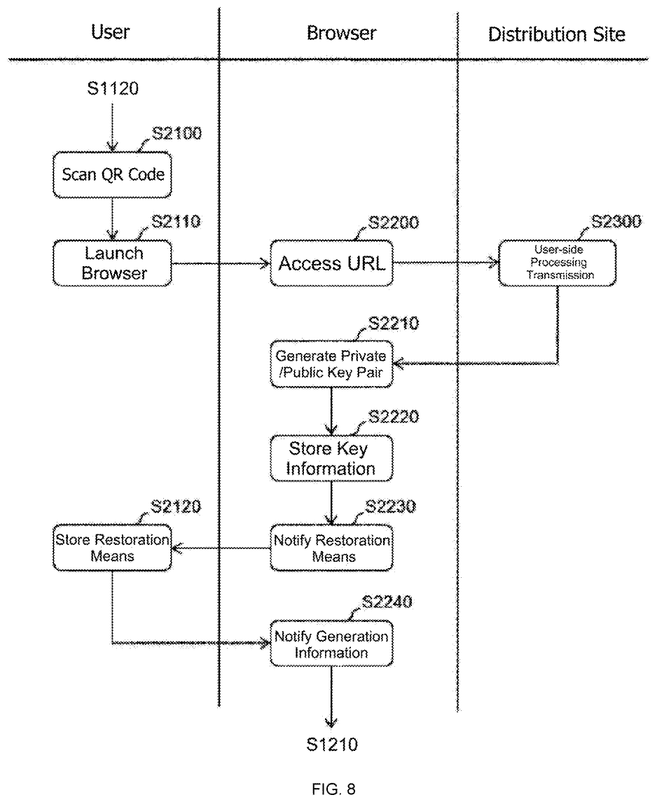

FIG. 8 is a diagram describing token receipt processing according to this Embodiment 3. The token receipt processing shown in FIG. 8 may be executed before Step S1210 as processing of Step S1200 in FIG. 3.

In Step S1200 of FIG. 3, as described above, users acquire information from distribution means. Specifically describing QR code cases, distribution means provide QR codes to users. This provision method may be any form, whether people handing over paper, posting QR codes at company entrances, or distributing via internet. Users read QR codes using smartphone camera application or scanner application (Step S2100). Depending on methods provided by distribution means, launched apps may change.

Next, when apps read this, they present URLs and confirm whether to access, and after users instruct “access,” smartphones launch browsers (Step S2110) and access URL destinations specified in token control information 600 (Step S2200). “Access” instructions may be automatically generated. That is, when apps read QR codes, access to URL destinations specified in token control information 600 may be automatically realized.

At this time, token control processing reception unit 300, which is the access destination distribution site, executes user-side processing transmission (Step S2300), and programs such as JavaScript (registered trademark) in pages provided by token control processing reception unit 300 generate key pairs that become the basis for user address creation (Step S2210), and execute processing to store key information related to key pairs including public key pairs and/or address information in browser local storage (Step S2220). Thus users can acquire unique address information in blockchain network 100 without being conscious of it. Also, local storage can only be used by users of that smartphone, so it can be said to be relatively safe.

In modified examples, key information (key pairs) may be stored in other browser storage such as browser session storage and browser cookies instead of browser local storage, or in storage areas other than browser storage (for example, storage areas within user terminal 400 or storage areas of server devices accessible by token control processing reception unit 300, etc.).

However, browser local storage can be deleted by user operations. If key pairs (especially private keys) are deleted, token movement granted to users becomes permanently unusable. To avoid this, after key pair creation, QR-coded image displays including records of key pair-related information or information used for their generation are presented to users as restorable (Step S2230).

These QR-coded image displays enable restoration of key pairs even when key pairs (especially private keys) are deleted from browser local storage by performing analysis. Therefore, QR-coded image displays become restoration means (backup QR/restoration information) enabling key pair restoration. Users can then capture QR-coded image displays (screens) or automatically save QR-coded image display information to locations other than browser local storage (for example, storage devices within smartphones or other cloud storage) (Step S2120). Therefore, if QR-coded image display information is saved, users can regenerate key pairs generated during access at any time, preventing waste of granted tokens.

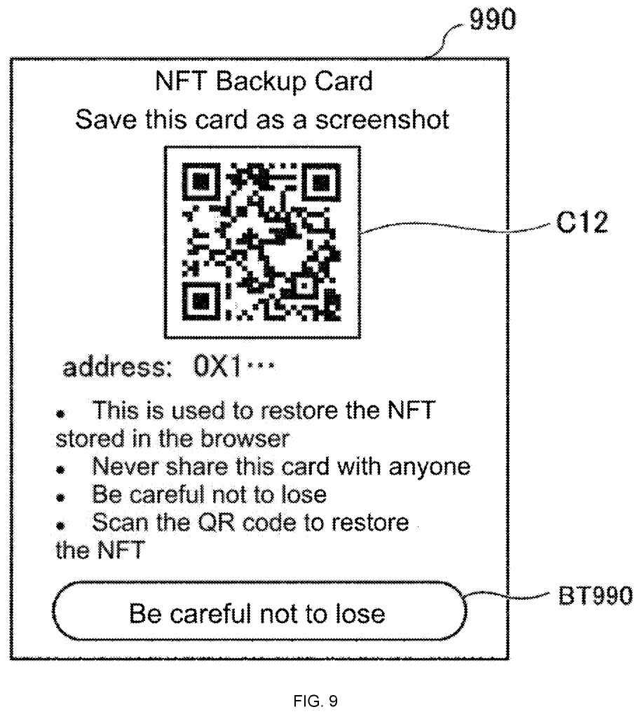

FIG. 9 shows an example of UI (User Interface) 990 prompting users to save restoration means. In this case, UI 990 includes messages prompting users to save image displays of QR code C12 serving as restoration means. Instead of QR codes, anything that can restore generated key pairs, such as combinations of multiple words or symbols or barcodes, may be used.

Key information (key pairs) stored in browser local storage can also be called temporary information for receipt. Therefore, after users obtain wallet addresses (addresses for permanent use, token storage locations) corresponding to wallet account numbers used from distribution sites, functions are provided to send target tokens to wallet addresses by providing sets of target tokens, wallet addresses, and restoration information, or sets of target tokens, wallet addresses, and key information stored in local storage to token control processing reception unit 300.

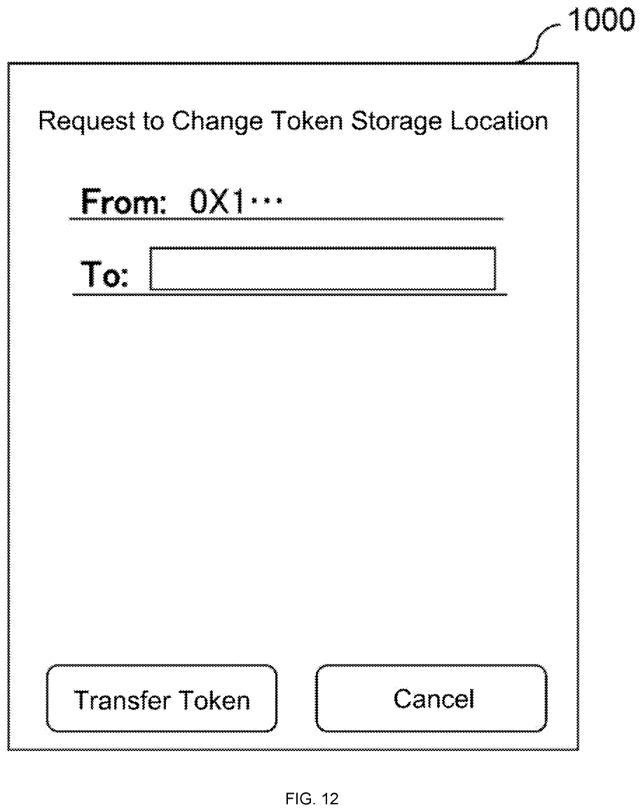

The UI image for this function of sending target tokens to wallet addresses is FIG. 12. “From” shown in FIG. 12 is automatically set because it is an address stored in local storage, but may be manually set (input). “To” shown in FIG. 12 is a column for inputting wallet information that can specify corresponding wallets, such as wallet addresses (addresses for permanent use) or their equivalents (for example, proxy processing addresses when going through proxy processing), and users input this themselves. This “To” may be set by reading from QR codes. Restoration information is held as separate files here.

Next, according to user instructions, processing for requesting NFT acquisition (Step S1210 processing in FIG. 3) is executed through processing for notifying generation information in browsers (Step S2240). From distribution means, token control information 600 is notified, and processing related to acquiring necessary information from this and performing encryption may be executed in processing related to notification of generation information (S2240). Parts or all of token control information 600 may be incorporated into corresponding URLs (Uniform Resource Locators/web page addresses displayed in browser address bars) or included in web pages developed based on corresponding URLs.

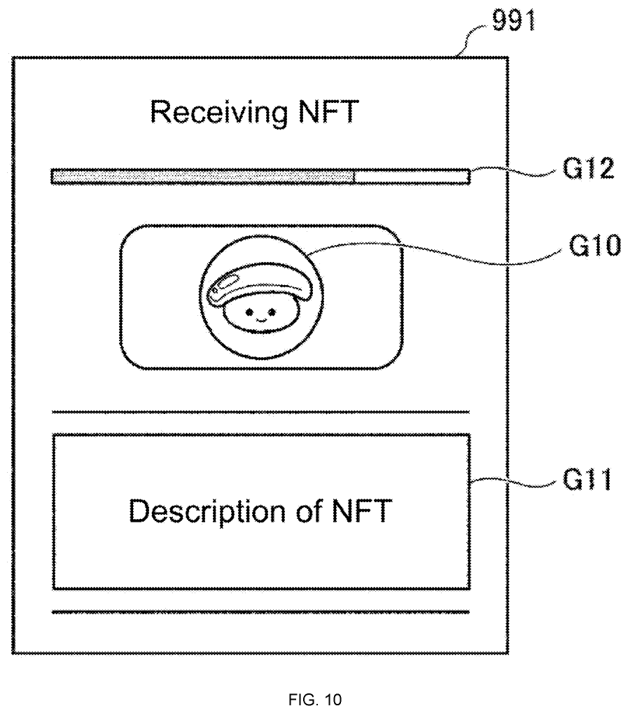

For example, in the screen example shown in FIG. 9, when users operate the button BT990 labeled message-namely, “Be careful not to lose” displayed in the lower screen area on smartphones, the processing of Step S1210 and subsequent steps in FIG. 3 is executed through Step S2240. In this case, on user smartphones, UI 991 shown in FIG. 10 may be output through screen 990 shown in FIG. 10.

In the screen example shown in FIG. 10, screen 990 is displayed including image G10 representing the NFT (token) to be acquired, description G11 of that NFT, processing indication G12 visually showing acquisition in progress, etc. Users can obtain information about NFTs being acquired by viewing screen 990. NFT description G11 may include advertising information related to distribution sources.

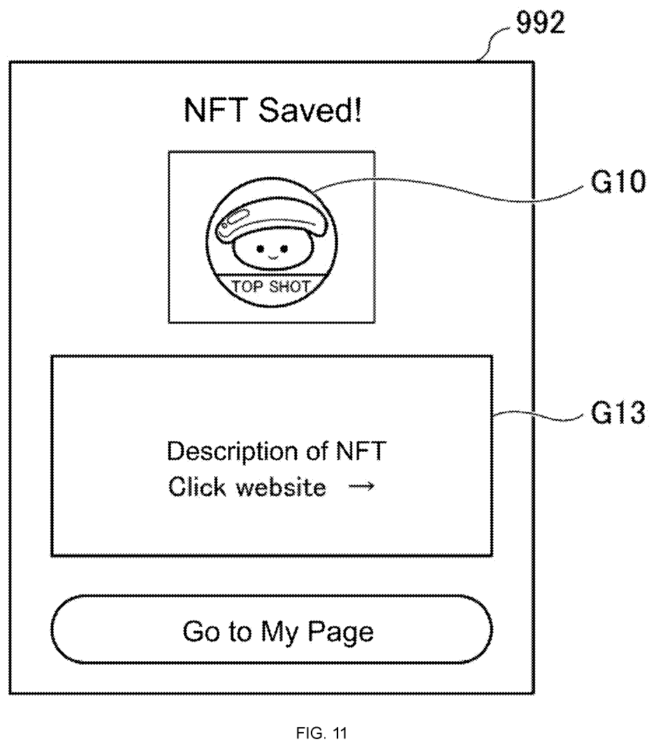

Next, UI 992 in the screen example shown in FIG. 11 is a screen displayed upon acquisition completion including the message “NFT Saved!” “Save” here refers to save in browser local storage as described above. UI 992 shown in FIG. 11 displays screen 990 including image G10 representing the saved NFT (token), description G13, etc. NFT description G13 may include links to more detailed description screens, links to advertising information sites, etc.

In the example shown in FIG. 8, processing for prompting restoration means storage (Step S2230) is executed in the restoration means notification processing, but this processing may be omitted or executed later as post-notification. Also, while address creation processing for public blockchains is not explicitly shown in FIG. 8, addresses are generated from public keys, so they may be created in key pair creation processing (S2210).

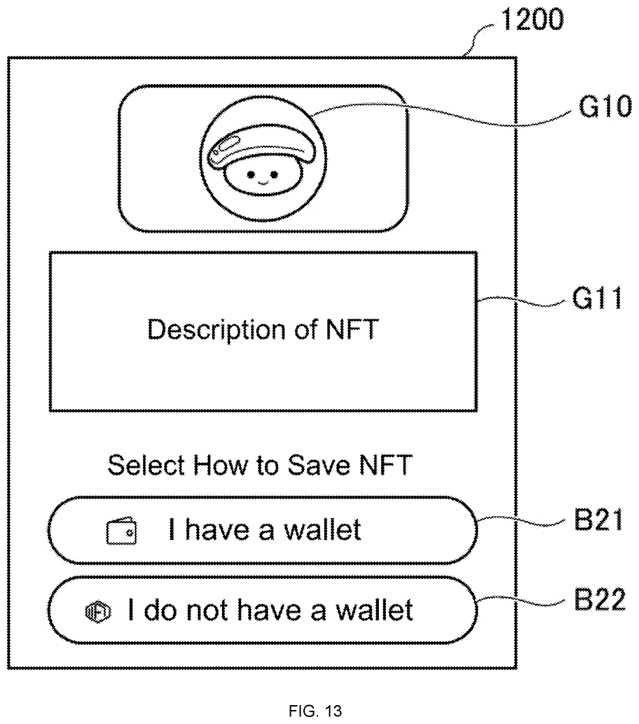

In this embodiment, display information (in this case, web screens) based on URL destinations specified in token control information 600 may have UI that allows selecting storage destinations for NFTs (tokens) to be acquired. For example, the example shown in FIG. 13 includes button B21 selectable by users who have wallets and button B22 suitable for selection by users who do not have wallets. When users operate button B21, target tokens are associated with wallet addresses, making the processing described above with reference to FIG. 12 unnecessary. On the other hand, when users operate button B22, various processing described above with reference to FIG. 8 is executed, enabling target token granting even to users who have wallets. By providing UI that allows selecting storage destinations for NFTs (tokens) to be acquired, highly convenient services can be provided to a wide range of users.

When requesting processing to blockchain network 100, fees called gas fees occur in many blockchains. These gas fees must be paid using tokens for gas fee related to virtual currencies in each blockchain, but general users find it difficult to secure tokens for gas fee themselves. Therefore, methods are provided where processing for blockchain network 100 is created using user key pairs, but gas fees necessary for requests are borne by token control processing reception unit 300.

User terminal 400 uses private keys of key pairs stored in browser local storage to sign token control information 600 received from distribution means and notify token control processing reception unit 300 of definitive usage, thereby requesting gas fee burden. At token control processing reception unit 300, senders can be reliably confirmed from sender information and signatures using user terminal 400, and bearing of gas fee can be permitted through this confirmation. Specifically, preparation is made in blockchain network 100 to enable executing gas fee burden proxy requests as smart contract-related processing, and proxy processing is executed by enabling requests to smart contract-related processing from token control processing reception unit 300.

By enabling proxy processing for blockchain network 100 at token control processing reception unit 300, users can request processing to blockchain network 100 without being conscious of gas fees.

The above also described methods for sending and storing held tokens to wallet addresses, but this can also be realized through proxy means without providing key information. There are two main ways: one is where users create processing requests to send and store target tokens from wallet addresses stored in local storage themselves, sign using key information (stored private keys, etc.) possessed in local storage, and request execution to token control processing reception unit 300. The other is creating processing requests to grant token control processing reception unit 300 authority to operate target tokens, signing using key information (stored private keys, etc.) possessed in local storage, and requesting execution to token control processing reception unit 300. In either case, token control processing reception unit 300 that received requests from user terminal 400 sets gas fees and requests smart contract-related processing that realizes proxy processing to complete processing.

When realizing wallet address (token storage location) changes through these means, items related to “restoration information” settings in UI 1000 shown in FIG. 12 are unnecessary, and methods such as presenting two methods for selection, implementing systems to use one of the two methods, and eliminating choices on UI are conceivable. When actually performing proxy processing, received data storage unit 700 in FIG. 5 is referenced to confirm whether requesting users are correct before requesting proxy processing to blockchain network 100. Also, feasibility of proxy execution may be determined by referencing received data storage unit 700 information.

For example, QR codes have many distributed pieces so gas fees are not subsidized, but users who acquired NFTs via audio are permitted, people who acquired through specific NFC within 3 days are given bearing of gas fee and small amounts usable as future gas fees, within 1 month only gas fee burden, beyond that not permitted, etc. may be controlled. By implementing such controls, multiple types of distribution means can be weighted, and variations in NFT distribution methods can be increased.

### Embodiment 4

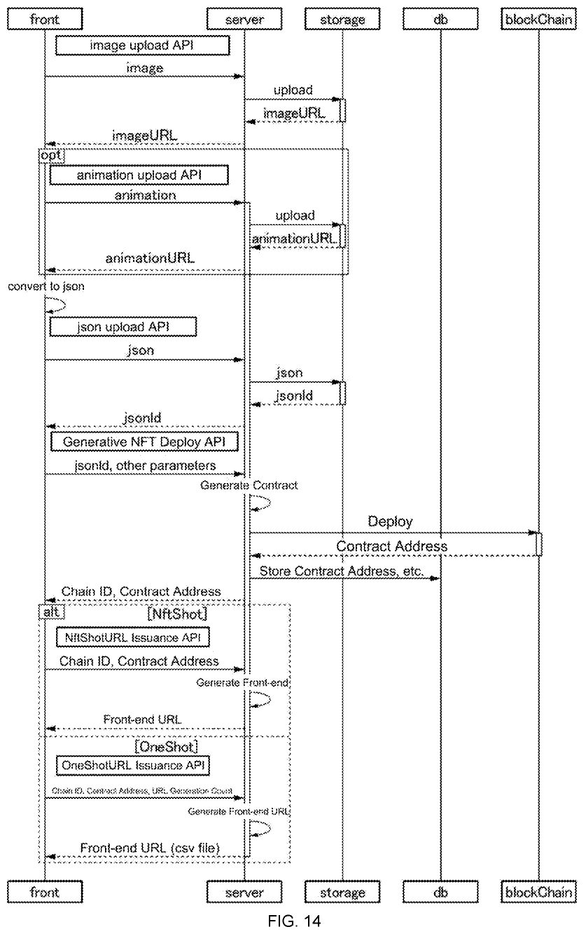

This Embodiment 4 relates to NFT (token) creation in each node 110 (an example of information processing devices), and FIGS. 14 to 23E are diagrams describing this Embodiment 4. Embodiment 4 creates and manages base information for NFTs (tokens) that can circulate on blockchain networks composed of multiple computers based on various inputs from users.

Here, base information is information manageable by issuers when issuing NFTs (tokens) and may be provided to information storage areas other than blockchain, for example, databases, browsers, etc.

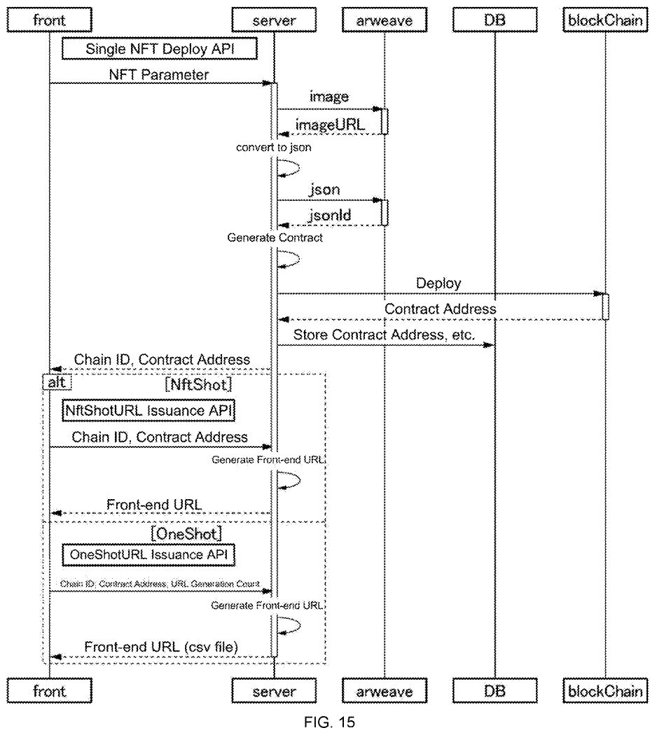

FIG. 14 describes generative NFT (token) creation, and FIG. 15 describes single NFT (token) creation, each showing flowchart examples. FIGS. 14 and 15 show flow examples between “front,” “server,” “storage or arweave,” “database,” and “blockchain,” and both differ, as shown in respective figures, in JSON conversion flows before generating contracts at servers but flows after deploying created NFTs (tokens) to blockchain are the same. Below, cases of creating single NFTs (tokens) are described as examples.

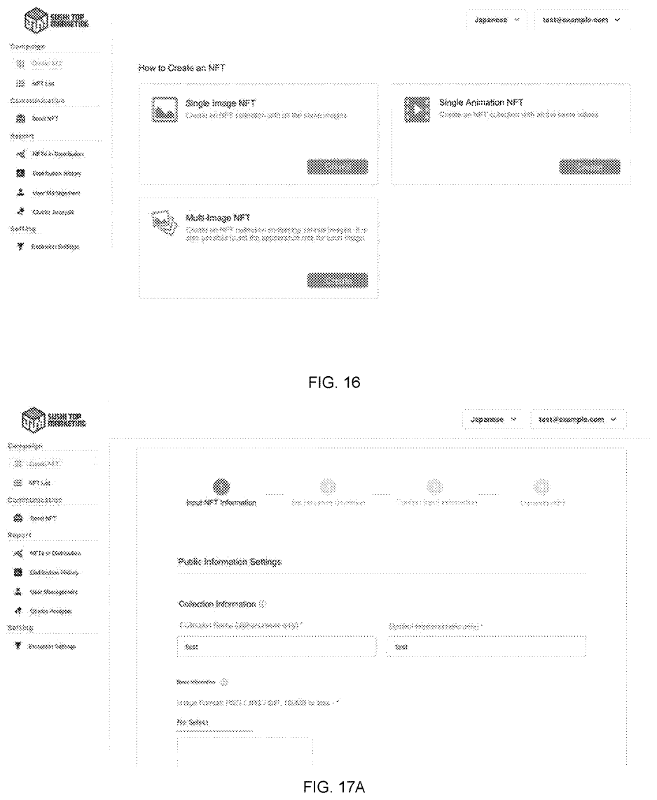

FIG. 16 shows an NFT (token) creation list. When selecting “NFT (token) creation” from the main menu, creation menus are displayed, and as illustrated in FIG. 16, creation menus may include three menus: “Single Image NFT,” “Multi-Image NFT,” and “Single Animation NFT.” The “Single Image NFT” menu is for creating NFT collections with all the same images. The “Multi-Image NFT” menu is for creating NFT collections containing various images and may enable setting appearance rates for each image. The “Single Animation NFT” menu is for creating NFT collections with all the same videos.

In each menu, users press “Create” buttons on screens to proceed with NFT (token) creation.

Below, NFT (token) creation procedures are described using cases where “Single Image NFT” menus are selected as examples. In this case, creation procedures include each step: Step 1 “Input NFT Information,” Step 2 “Set Issuance Condition,” Step 3 “Confirm Input Information,” and Step 4 “Generate NFT.”

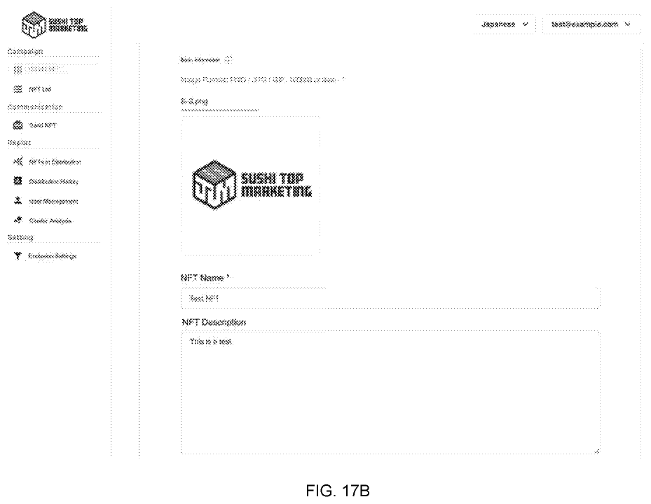

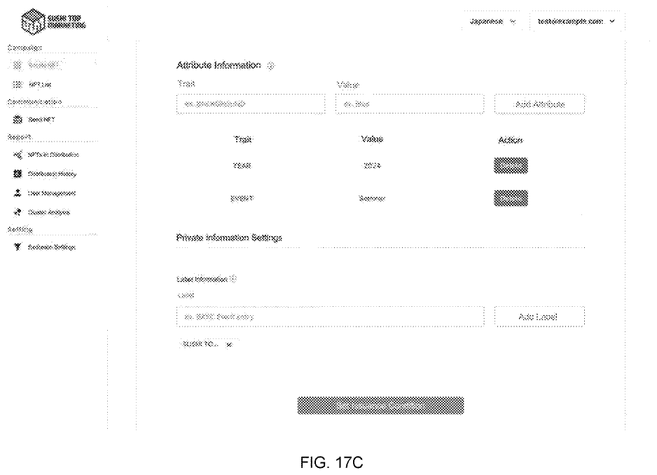

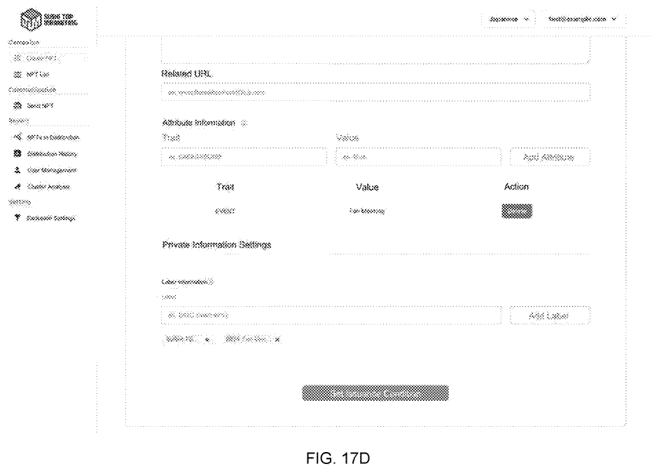

FIGS. 17A, 17B, 17C, and 17D illustrate screens used for Step 1 “Input NFT Information.” Here, examples are shown where screens are used while scrolling, and FIGS. 17A, 17B, and 17C show screens in order from top according to scrolling, including some overlapping parts. FIG. 17D shows partially modified examples of FIG. 17C (when collectively referring to FIGS. 17A, 17B, 17C, and 17D, they may be called FIG. 17).

In this “Input NFT Information” screen, as shown in FIGS. 17A, 17B, and 17C, public information settings input “Collection Information” (collection name, symbol), “Basic Information” (image selection, NFT name, NFT description), “Attribute Information” (trait, value, add attribute), and private information “Label Information” (label, add label). When input is finished, the “Set Issuance Condition” button (see FIG. 17C) is pressed to proceed to Step 2. As shown in FIG. 17D, “Value/Seminar” in FIG. 17C may be replaced with “Value/Fan Meeting,” etc. This information may collectively be called predetermined information. Here, “Label” and “Label Information” refer to user attributes (interests) such as “Education,” “Art,” “Music,” etc., as described later.

Here, base information may include information indicating that third parties cannot view it on blockchain as predetermined information (property information, label information).

NFTs (tokens) linked to base information are displayed as a viewable “Created NFT (token) list” as described later. Viewable NFTs (tokens) are associated with issuance access information (URLs, etc.).

Based on various inputs from users described above, base information for tokens that can circulate on blockchain networks composed of multiple computers is automatically generated. In conventional technology, NFTs (tokens) are issued after inquiries and review results between inputs, but in this Embodiment 4, blockchain writing occurs at the timing respective “Create” buttons are pressed, enabling speedy NFT (token) issuance.

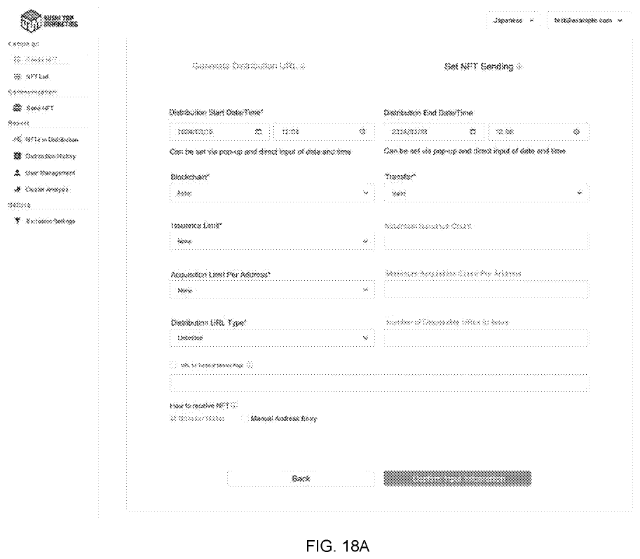

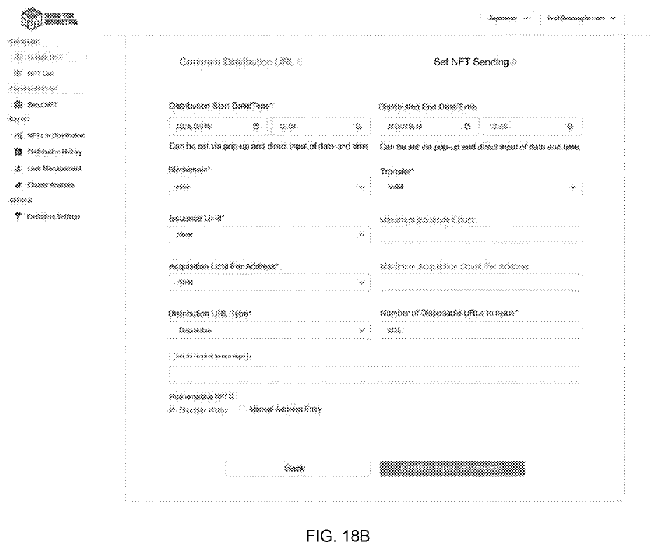

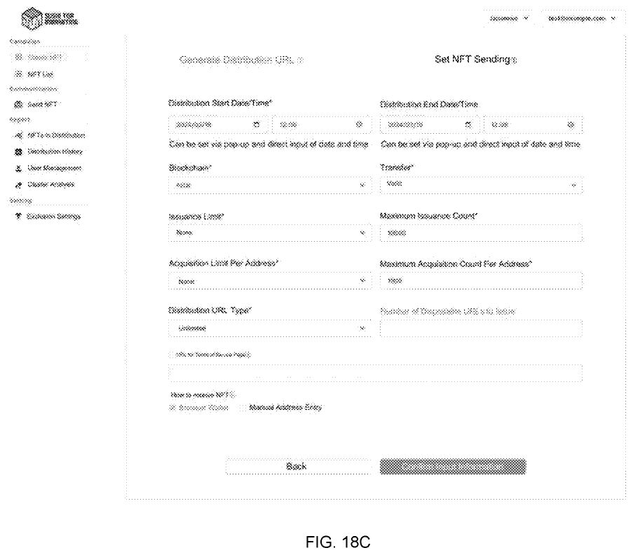

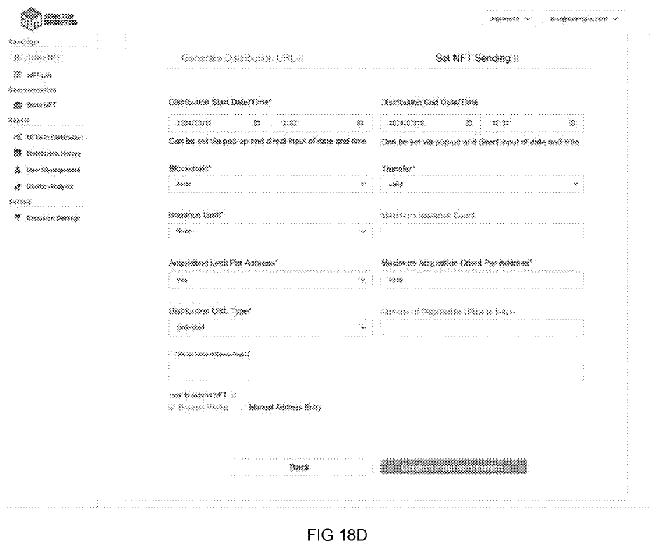

FIGS. 18A, 18B, 18C, 18D, and 18E illustrate screens used for Step 2 “Issuance Condition Settings,” and each figure shows cases where respective items are selected or input in different manners (when collectively referring to FIGS. 18A, 18B, 18C, 18D, and 18E, they may be called FIG. 18). In the “Issuance Condition Settings” screen of FIG. 18A, “Distribution URL Settings” and “NFT Sending Settings” select or input numerical values for “Distribution Start Date and Time,” “Distribution End Date and Time,” “Blockchain Name,” “Transfer Valid/Invalid” (shown as “Enable”), “Issuance Limit Yes/None” (shown as “None”), “Acquisition Limit Per Address Yes/None” (shown as “None”), and “Distribution URL Type Unlimited/Disposable” (shown as “Unlimited”). When “Disposable” is selected for “Distribution URL Type,” “Number of Disposable URLs to Issue” is input. Thus, base information for NFTs (tokens) may include, as an attribute. information indicating whether disposable is possible. When input is completed, the “Confirm Input Information” button is pressed to proceed to Step 3.

Regarding other figures, differences from FIG. 18A are described as follows. FIG. 18B shows examples of “Distribution URL Type: Disposable” and “Number of Disposable URLs to Issue: 1000.” FIG. 18C shows examples of “Issuance Limit: Yes,” “Maximum Issuance Count: 10000,” “Acquisition Limit Per Address; Yes,” “Maximum Acquisition Count Per Address: 1000,” and “Distribution URL Type: Unlimited.” FIG. 18D shows examples of “Issuance Limit: None,” “Acquisition Limit Per Address: Yes,” “Maximum Acquisition Count Address: 1000,” and “Distribution URL Type: Unlimited.” FIG. 18E shows examples of “Issuance Limit: None,” “Acquisition Limit Per Address: None,” and “Distribution URL Type: Unlimited.”

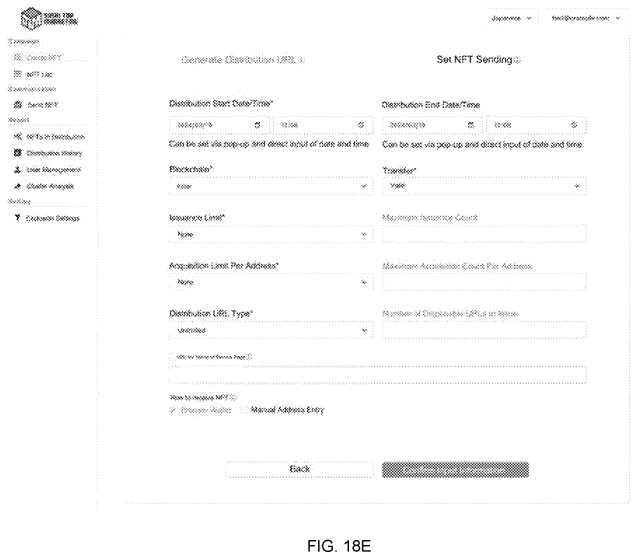

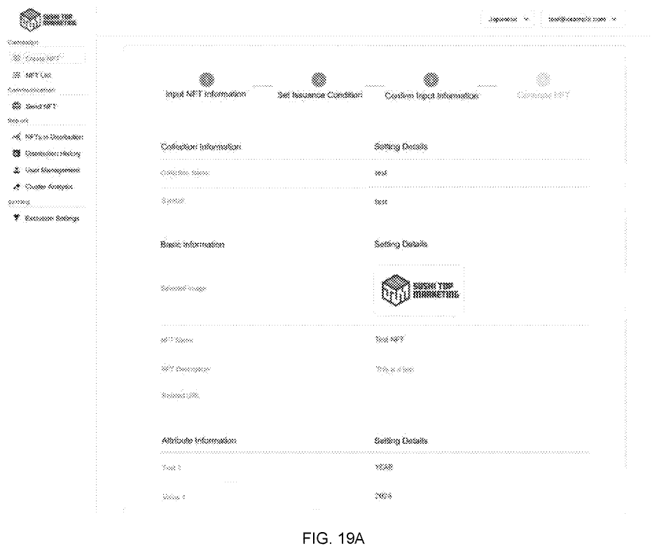

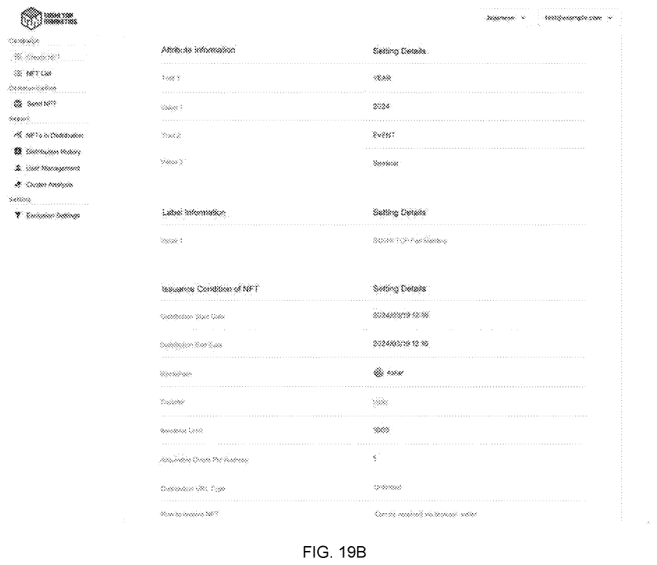

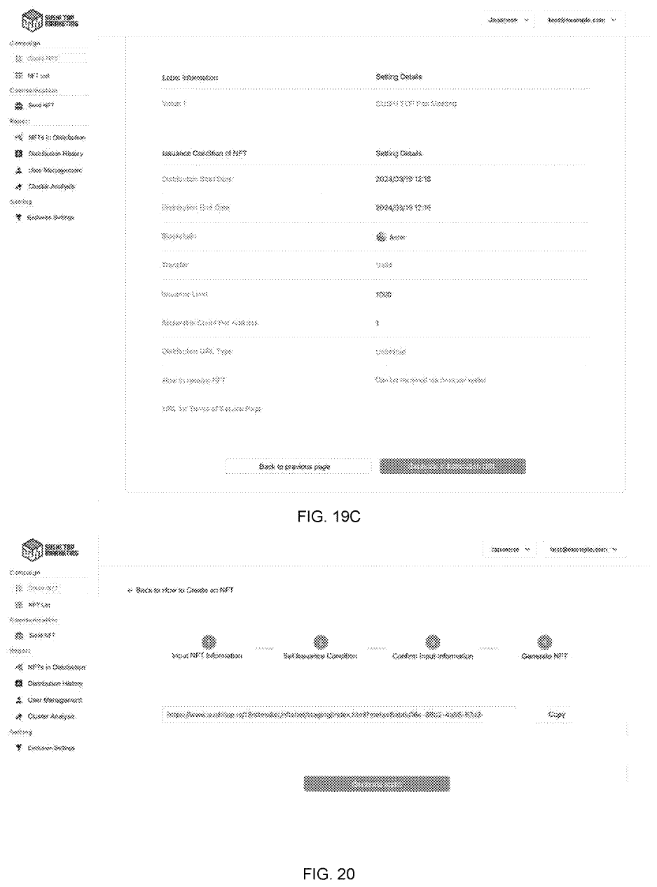

FIGS. 19A, 19B, and 19C illustrate screens used for Step 3 “Confirm Input Information.” Here, examples are shown where screens are used while scrolling, and FIGS. 19A, 19B, and 19C show screens in order from top according to scrolling, including some overlapping parts (when collectively referring to FIGS. 19A, 19B, and 19C, they may be called FIG. 19).

In this “Confirm Input Information” screen, as shown in FIGS. 19A, 19B, and 19C, input contents are displayed for “Collection Information” (collection name, symbol), “Basic Information” (selected image, NFT name, NFT description, related URL), “Attribute Information” (trait, value <FIG. 19A illustrates one set of traits and values, FIG. 19B illustrates two sets of traits and values>), private information “Label Information” (labels <FIG. 19B illustrates fan meetings>), and “Issuance Condition of NFT” (distribution start date, distribution end date, blockchain, transfer, issuance limit, acquirable count per address, distribution URL type, how to receive NFT). When confirmation is completed, the “Generate a distribution URL” button (see FIG. 19C) is pressed to proceed to Step 4.

FIG. 20 illustrates a screen for “confirming a distribution URL” as Step 4 “Generate NFT.” On this screen, a “Distribution URL List” is displayed. When confirmation is finished, to create new NFTs (tokens), the “Generate again” button is pressed to proceed to Step 1.

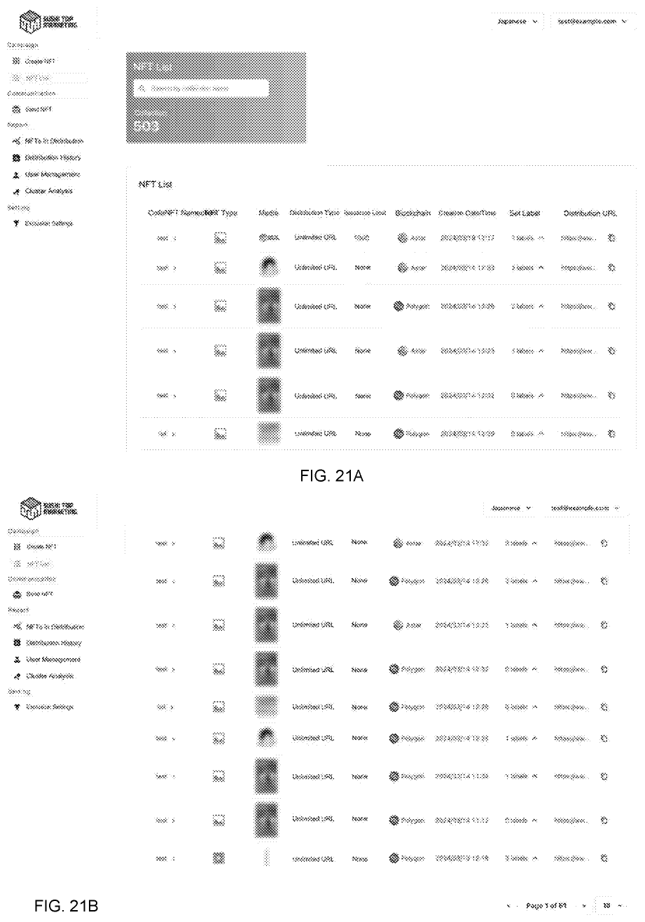

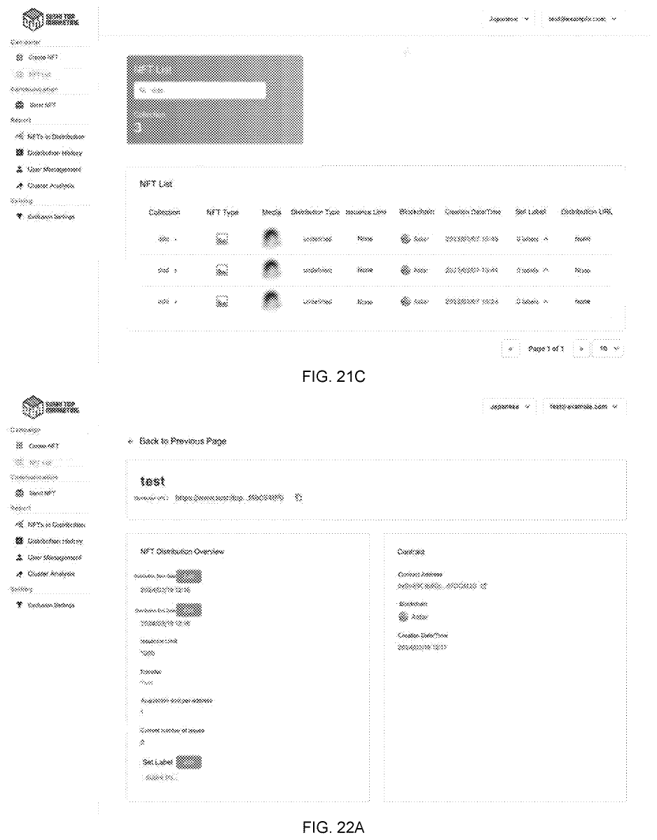

NFTs (tokens) created through the above steps are displayed in a list on screens used for “Created NFT (token) List” when “Created NFT (token) List” is selected from main menus. FIGS. 21A, 21B, and 21C show examples of the list, displaying screen examples organized by items such as “Collection,” “NFT Type,” “Media,” “Distribution Type,” “Issuance Upper Limit,” “Blockchain,” “Creation Date and Time,” “Set Labels,” and “Distribution URLs.” FIGS. 21A and 21B show examples displaying all created NFTs (tokens), shown in order from top according to scrolling, including some overlapping parts. “Created NFT (token) List” may be searchable by “Collection,” and FIG. 21C shows examples displaying applicable items by searching “Collection” for “ddd” (when collectively referring to FIGS. 21A, 21B, and 21C, they may be called FIG. 21).

“Created NFT (token) list” may be displayed by individual NFTs (tokens), and FIGS. 22A and 22B show examples displaying specific NFTs (tokens), showing screen examples organized by items “NFT Distribution Overview,” “Contract,” and “Metadata.” FIGS. 22A and 22B show screens in order from top according to scrolling, including some overlapping parts (when collectively referring to FIGS. 22A and 22B, they may be called FIG. 22). In figures, “Contract” and “Contract Address” may be replaced with “Wallet” and “Wallet Address” respectively (same applies to FIGS. 14, 15, and 23A).

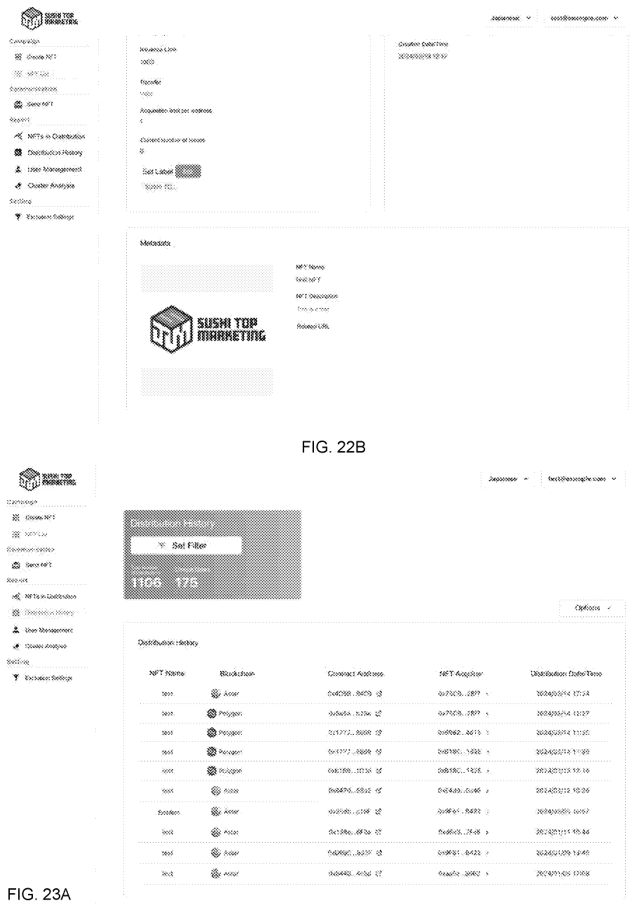

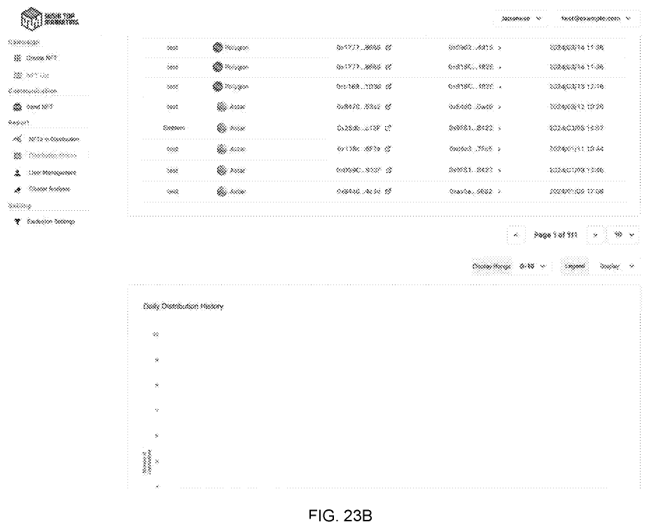

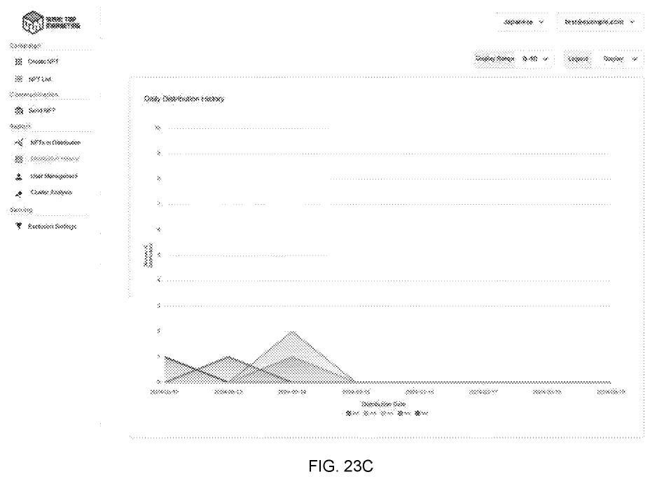

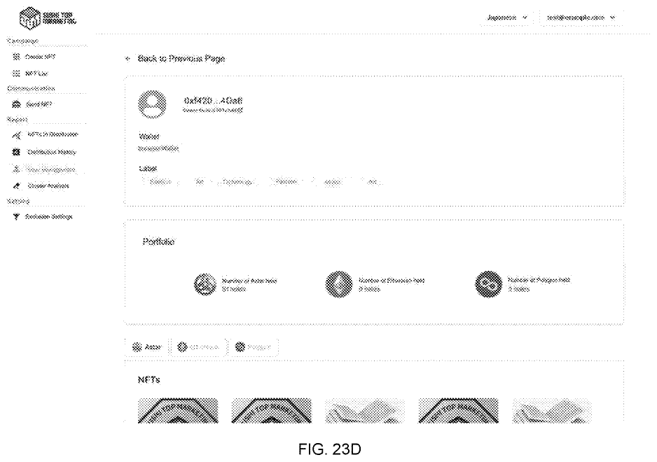

In addition, distribution situations of created NFTs (tokens) may be displayed as viewable, and other tokens linked to contract addresses or wallet addresses of NFT (token) distribution destinations may be displayed as viewable for reporting. FIGS. 23A, 23B, and 23C show screen examples displaying distribution situations of created NFTs (tokens) when “Distribution History” is selected from main menus. Here, examples are shown where screens are used while scrolling, and FIGS. 23A, 23B, and 23C show screens in order from top according to scrolling, including some overlapping parts (when collectively referring to FIGS. 23A, 23B, 23C, and later-described FIGS. 23D and 23E, they may be called FIG. 23).

Here, for NFT (token) distribution, it is preferable to divide into primary distribution and secondary distribution as utilities. Primary distribution is normal distribution, and secondary distribution distributes new NFTs (tokens) to people possessing specific NFTs (tokens), for example, at anniversary timing. Secondary distribution may be configured with push notifications, though not mandatory.

As shown in FIGS. 23A, 23B, and 23C, NFT (token) distribution situations may be displayed through “Distribution History” and “Daily Distribution History.” “Distribution History” may be organized by items such as “NFT Name,” “Blockchain,” “Contract Address,” “NFT Acquirer,” and “Distribution Date/Time.” “Daily Distribution History” may be graphed with “Distribution Date” as horizontal axis and “Distribution Number” as vertical axis to make daily distribution numbers easily visible. This information including “Distribution History” may be grasped as customer identification information.

When base information related to other tokens linked to token distribution destination contracts or wallets has tags set as predetermined information or includes label information, multiple tokens linked to contracts or wallets can be classified based on predetermined information. Customer identification information described above may be generated based on information acquirable based on token distribution destination contract addresses or wallet addresses. Furthermore, advertising information may be generated based on customer identification information.

In addition, as shown in FIGS. 23D and 23E, NFT (token) distribution situations may be managed through “User Management” for each user (NFT acquirer). For example, users are grasped through wallet addresses, wallet types, NFT acquisition numbers, held labels, etc. This enables grasping customer (wallet) activities through labels for each token and visualizing loyalty.

As described above, created NFTs (tokens) can be distributed using methods shown in FIGS. 1 to 13.

### Embodiment 5

This Embodiment 5 performs on-chain community detection (on-chain cluster detection) as part of user management. Two methods can be configured for on-chain community detection (on-chain cluster detection):
Method 1: “Wallet Clustering Using Off-chain Label Information”
Method 2: “Similarity Evaluation Between Wallet Clusters (Label Groups)”
   Below, “Overview,” “Provided Value,” “Implementation Examples,” and “Calculation Processing/Drawing Processing” are described for each method.

### <Method 1>

“Wallet Clustering Using Off-chain Label Information”

### <<Overview>>

As an overview of Method 1, basic concepts and purposes of systems proposed reflecting this invention are described.
Wallet Node Position Calculation Processing:
   Positions of each wallet node are calculated based on weighted averages of positions of related label nodes. This process forms positional relationships of wallet nodes on graphs and defines relative positions of wallets within networks.
Wallet Node Cluster Classification:
   Wallet nodes are classified into clusters based on labels they belong to. Classification is determined by labels most associated with wallet nodes, indicating which level (or cluster) wallets are most strongly connected to.
Node and Edge Addition (Network Graph Drawing):
   Based on calculated positions and cluster classifications, wallet nodes and label nodes are added to graphs. This forms edges between nodes, visualizing direct relationships between wallets and labels.

### <<Provided Value>>

As provided value of Method 1, specific advantages brought by proposed systems and technologies and problems that can be solved are described.
On-chain Community Detection and Analysis:
   Graph construction combining on-chain and off-chain data enables visualizing and detecting on-chain communities that were difficult to see with conventional methods. This process enables deep understanding of interactions and structures within communities by clustering relationships between wallets.
Data Segmentation Through Filtering:
   Filtering based on selected labels, wallet types, and minimum NFT numbers enables focusing on more relevant data subsets, highlighting communities meeting specific conditions and enhancing analysis efficiency. For example, it becomes possible to identify wallet groups participating in specific events or projects and analyze behavioral trends and relationships of those communities.

### Implementation Examples

As implementation examples of Method 1, specific scenarios and case studies of how technologies and systems actually function are described. This implementation example provides methods and systems for deeper on-chain community detection and analysis by complementing on-chain information with off-chain information (labels attached to NFTs, wallet owner social media activities such as likes, comments, shares) when on-chain information alone may be incomplete. Rather than depending only on on-chain information, this implementation example provides new methods for richer visualization of blockchain communities and deeper understanding of their structures and dynamics by complementing on-chain information with off-chain information. This enables wide-ranging applications such as blockchain ecosystem analysis, marketing strategy formulation, and security monitoring. Items are described below.

### (1) Integration of On-Chain and Off-Chain Information.

In addition to on-chain information such as transactions and wallet addresses, off-chain information indicating wallet behavioral patterns, communities they may belong to, and interests (label information attached to NFTs, social “likes” and “statements”) is integrated.

### (2) Graph Visualization

Integrating on-chain and off-chain information, graphs are constructed expressing wallets and transactions as nodes and their relationships as edges.

### (3) On-Chain Community Detection

Through node clustering on graphs, relationships and groups emphasized by off-chain information within on-chain communities are identified.
These clusters are interpreted as wallet communities sharing specific interests or activities.

### (4) Analysis and Insight Extraction

By utilizing off-chain information, wallet interactions and deep community dynamics invisible through transaction data alone are revealed, and roles and influence of each community within blockchain ecosystems are evaluated through community characteristic analysis.

### (5) Filtering and Segmentation.

Filtering based on off-chain information can be applied to focus on communities related to specific interests or behavioral patterns.
Detection of communities meeting specific conditions or criteria enhances analysis efficiency and provides more detailed insights.

### <<Calculation Processing/Drawing Processing>>

As calculation processing/drawing processing of Method 1, calculation logic and algorithms behind proposed systems are described.

### (1) Wallet Node Position Calculation

Position P_{w} of wallet node w is calculated. Position P_{w} is the finally obtained position, indicating positions considering positions and influence degrees of all related labels.

$${P}_{w} = \frac{1}{L} {\sum }_{l ∈ Labels} ( P [ l ] \cdot c [ l ] ) \qquad [ Formula 1 ]$$

P[I] is the position vector of individual label I, representing coordinates of label I on graphs.
c[I] is the weight coefficient of label I associated with wallet nodes, indicating “influence degree” of label I on wallet node w. For example, if wallet nodes are strongly associated with certain labels, weight coefficients c [I] of those labels take large values.
P[I]·c[I] is the product of each label's position vector and its weight coefficient, obtaining positions considering “substantial” influence degrees on wallet nodes by multiplying label positions by their weight coefficients.
1/L is used to average summed location information. L is the total number of labels associated with wallet nodes, and average values are calculated by dividing by this number.
The above formula performs calculations considering positions and weights of each label associated with wallet nodes, averaging them to determine wallet node positions, indicating which labels wallet nodes are “near” and which label groups they are deeply “related” to.

### (2) Wallet Node Cluster Classification

Among labels associated with wallet node w, the set S w of labels most frequently associated is calculated.

$${S}_{w} = \{ l ∈ {L}_{w} : {count}_{w} ( l ) = {max}_{{l}^{′} ∈ {L}_{w}} {count}_{w} ( {l}^{′} ) \} \qquad [ Formula 2 ]$$

Count _{w}(I) indicates occurrence counts of specific labels I associated with wallet node w.
max _{r∈Lw}count _{w}(I′) means finding maximum occurrence counts of arbitrary labels I within L_{w}.
count _{w}(I) is the number of times label I is associated with wallet node w.
S_{w} means the set of labels most frequently associated with wallet node w.
The above formula uses max operators to compare occurrence counts count _{w}(I′) of each label I′ within set L_{w}, derive labels with maximum values (maximum occurrence counts), and show sets containing all labels with maximum occurrence counts.
For example, when possessing labels “Fashion,” “Technology,” “Fashion,” this results in “Fashion”: 2 times, “Technology”: 1 time, so S w includes “Fashion.”

### (3) Node and Edge Addition (Network Graph Drawing)

Wallet Node Addition:
   For each wallet, wallet nodes are added to graphs based on calculated positions (weighted averages of positions of label nodes related to wallets) and clusters they belong to (labels most associated).
   Wallet nodes include attributes such as wallet addresses, wallet types, numbers of original NFTs held by wallets, and related labels.
   Wallet node colors are determined according to clusters they belong to. Wallets not belonging to specific clusters are assigned default colors.
Label Node Addition:
   Label nodes are created for all tags in datasets, and each label node is positioned at specific locations on graphs.
   Label nodes include information such as tag names and lists of related wallet addresses.
Edge Addition:
   Edges are formed between wallet nodes and related label nodes in graphs.
   These edges visually show which tags (clusters) wallets are related to, representing relationships between wallets and tags.
   Through edges, diversity of tags held by wallets and degrees of relationship to specific tags are visualized.

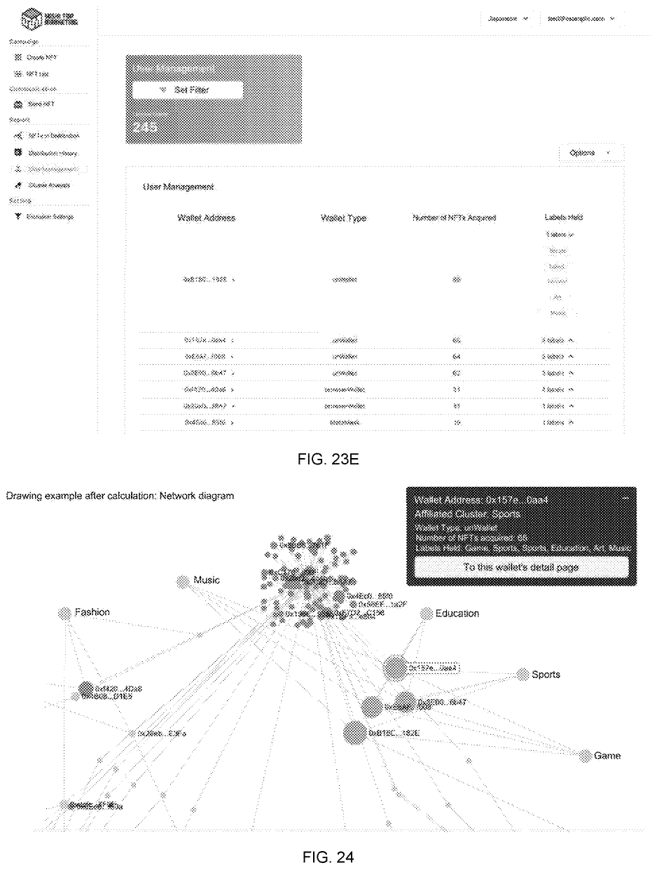

Through these steps, relationships between wallets and tags become clear, enabling users to easily understand mutual relationships and cluster membership states of wallets within networks through graphs. As drawing examples after these calculation processes, network diagrams are shown in FIG. 24.

### <Method 2>

“Similarity Evaluation Between Wallet Clusters (Label Groups)”

### <<Overview>>

As an overview of Method 2, basic concepts and purposes of systems proposed reflecting this invention are described.
Wallet Vectorization Based on Labels:
   Each wallet is vectorized based on label presence/absence, expressed as “1” when labels exist and “0” when they don't exist.
Label Group Vector Creation:
   For each label, vectors of all wallets containing that label are summed to create label group vectors. These vectors represent total numbers of wallets related to those labels.
Tag Group Vector Comparison Using Cosine Similarity:
   By calculating cosine similarity between label group vectors, label similarity is evaluated. Higher similarity can be interpreted as tag groups sharing more similar wallet characteristics.

### <<Provided Value>>

As provided value of Method 1, specific advantages brought by proposed systems and technologies and problems that can be solved are described.
Relationship Visualization:
   Through similarity evaluation between label groups, patterns such as “users with certain specific labels tend to also have other specific labels simultaneously” can be clarified.
   This enables visually capturing strong connections between related labels and can lead to discovering new communities.

### Implementation Examples

As implementation examples of Method 2, specific scenarios and case studies of how technologies and systems actually function are described. This implementation example provides algorithms for evaluating similarity between wallets on blockchain and deeply analyzes similarity between wallet clusters by integrating off-chain information (labels attached to NFTs, wallet owner social media activities such as likes, comments, shares) in addition to on-chain information of wallet owners. Through this approach, blockchain community structures can be more accurately grasped and highly related clusters can be identified. Because not only which NFTs wallets possess but also what interests (values) those wallet owners have can be evaluated from multifaceted perspectives, value-based marketing based on inferring wallet owner values becomes possible. Items are described below.

### (1) Integration of On-chain and Off-chain Information:

For each wallet, NFT label data and social media activity data (likes, comments, shares) are integrated, and each data point is linked to related wallet identifiers (wallet addresses).

### (2) Extended Label Vector Generation:

For all wallets, vectors including unique labels (NFT labels and social media activity indicators) are generated. For example, when wallets have specific NFT labels, 1 is placed in corresponding positions, and when specific social media behaviors (likes, etc.) are performed, 1 is similarly placed, performing one-hot encoding.

### (3) Vector Aggregation and Similarity Calculation:

Using extended vectors generated for each wallet, similarity between wallet clusters is evaluated. Cosine similarity is calculated between each wallet vector to quantify how much similar characteristics wallets share.

### (4) Heatmap Data Generation:

Based on cosine similarity calculation results, heatmaps are generated to visualize similarity between wallet clusters. This enables intuitive understanding of relationships by clusters.

### <<Calculation Processing/Drawing Processing>>

As calculation processing/drawing processing of Method 2, calculation logic and algorithms behind proposed systems are described.

### (1) Wallet Vectorization

Label presence/absence for each wallet is expressed as “1” and “0” respectively.

TABLE 1

| | Label A | Label B | Label C | |
|---|---|---|---|---|
| walletAddress A | 1 | 0 | 1 | [1, 0, 1] |
| walletAddress B | 0 | 1 | 0 | [0, 1, 0] |
| walletAddress C | 1 | 1 | 0 | [1, 1, 0] |
| walletAddress D | 1 | 0 | 1 | [1, 0, 1] |

### (2) Group Vector Creation for Each Label Group

For each label group, numerical values of walletAddress A/B/C/D are summed to create group vectors. Taking label A group as an example, since walletAddress B doesn't exist, the following group vector is obtained for applicable walletAddress A/C/D.

TABLE 2

| | Label A | Label B | Label C | |
|---|---|---|---|---|
| walletAddress A | 1 | 0 | 1 | [1, 0, 1] |
| walletAddress C | 1 | 1 | 0 | [1, 1, 0] |
| walletAddress D | 1 | 0 | 1 | [1, 0, 1] |

Group vectors are similarly created for label B and C groups, and combining label A-C groups yields the following table.

TABLE 3

| | Label A | Label B | Label C | |
|---|---|---|---|---|
| Label A group | 3 | 1 | 2 | [3, 1, 2] |
| Label B group | 1 | 2 | 0 | [1, 2, 0] |
| Label C group | 2 | 0 | 2 | [2, 0, 2] |

### (3) Cosine Similarity Calculation

Using vectors of each group obtained in (2) above, vector directions are determined using “cosine similarity.” Cosine similarity calculates how similar vectors are to each other, determining that the closer vector directions are, the higher the similarity. In this implementation example, since components are non-negative vectors, angles range from minimum 0 degrees to maximum 90 degrees, but calculating angle cosines yields “1” at 0 degrees and “0” at 90 degrees. When calculation results are “1,” this is determined as “vector angle is 0 degrees=same direction vectors=match,” and when “0,” this is determined as “vector angle is 90 degrees=independent/orthogonal vectors=unrelated,” with values closer to “1” having higher similarity.

Cosine similarity is obtained by dividing inner products of both vectors by products of each vector norm for compared vector q and vector d, as shown in the following formula.

$$cos ( \vec{q} , \vec{d} ) = \frac{\vec{q} \cdot \vec{d}}{\vert \vec{q} \vert \vert \vec{d} \vert} = \frac{\vec{q}}{\vert \vec{q} \vert} \cdot \frac{\vec{d}}{\vert \vec{d} \vert} = \frac{{\sum }_{i = 1}^{\vert V \vert} {q}_{i} {d}_{i}}{\sqrt{{\sum }_{i = 1}^{\vert V \vert} {q}_{i}^{2}} \cdot \sqrt{{\sum }_{i = 1}^{\vert V \vert} {d}_{i}^{2}}} \qquad [ Formula 3 ]$$

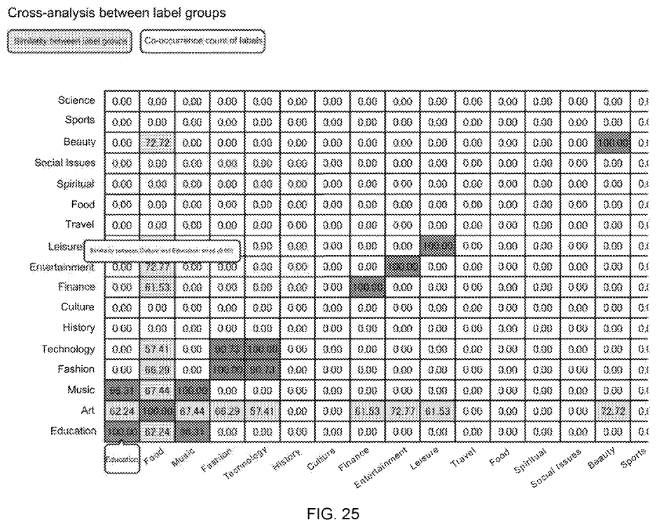

As drawing examples after these calculation processes, examples of cross-analysis between label groups are shown in FIG. 25. In figures, 17 labels are illustrated on vertical and horizontal axes: Education, Art, Music, Fashion, Technology, History, Culture, Finance, Entertainment, Leisure, Travel, Food, Spiritual, Social Issues, Beauty, Sports, and Science.

FIG. 25 shows cosine similarity between label groups, displaying numerical values multiplied by 100 for visibility. Places where vertical and horizontal axes have the same labels show similarity 100.00, and similarity between different labels on vertical and horizontal sides is displayed line-symmetrically around that line. For example, “Education/Art” shows cosine similarity 62.24, and “Education/Music” shows cosine similarity 96.31. In FIG. 25, visibility may be enhanced by color-coding or varying shapes of graph cells according to desired ranges based on similarity levels.

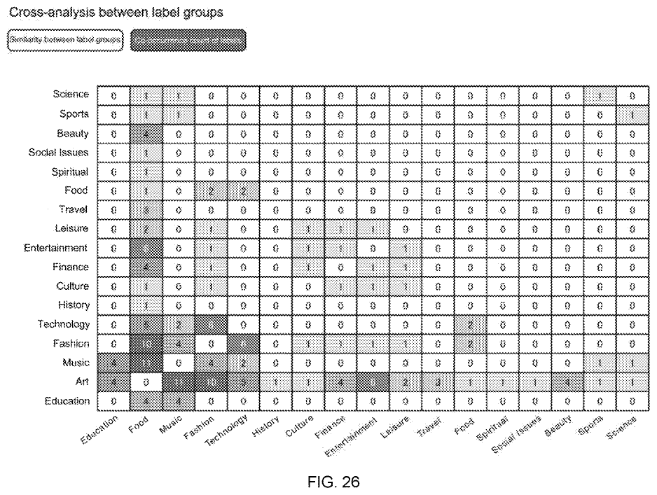

FIG. 26 shows examples when similarity is measured by label co-occurrence counts rather than cosine similarity. In figures, the same labels as FIG. 25 are taken on vertical and horizontal axes, and places where the same labels meet are blank. Co-occurrence counts between different labels on vertical and horizontal sides are displayed line-symmetrically around that line. When measuring similarity by co-occurrence counts, both “Education/Art” with cosine similarity 62.24 and “Education/Music” with cosine similarity 96.31 show co-occurrence counts of 4, showing different trends from cosine similarity measurements that capture vector directions. In FIG. 26, visibility may be enhanced by color-coding or varying shapes of graph cells according to desired ranges based on co-occurrence count levels.

The embodiments of this invention have been described in detail with reference to drawings, but specific configurations are not limited to these embodiments and include designs within the scope of this invention.

### DESCRIPTION OF REFERENCE NUMERALS

100 . . . Blockchain network, 600 . . . Token control information, 700 . . . Received data storage unit, 800 . . . Token management information, 900 . . . Token distribution number management, 1000 . . . Token storage location change UI

1. An information processing device that automatically generates base information for tokens that can circulate on networks related to blockchain composed of multiple computers, based on various inputs from users.

2. The information processing device according to claim 1, wherein the base information includes, as an attribute of the tokens, information indicating whether the tokes are disposable.

3. The information processing device according to claim 1, wherein the base information includes predetermined information that third parties cannot view on the blockchain.

4. The information processing device according to claim 1, which displays the tokens linked to the base information as viewable.

5. The information processing device according to claim 4, wherein the viewable tokens are associated with access information for issuance.

6. The information processing device according to claim 1, which displays distribution situations of the tokens as viewable.

7. The information processing device according to claim 1,
which displays other tokens linked to wallets of the token distribution destinations as viewable.

8. The information processing device according to claim 3, wherein when the base information related to other tokens linked to the token distribution destination wallets includes label information as the predetermined information, multiple tokens linked to the wallets can be classified based on the predetermined information.

9. The information processing device according to claim 8, which generates customer identification information including distribution history based on information acquirable based on the token distribution destination wallet addresses.

10. The information processing device according to claim 9, which generates advertising information based on the customer identification information.

11. The information processing device according to claim 1, which displays information that can specify distribution locations and distribution events as viewable for each wallet address.

12. The information processing device according to claim 1, including other features shown in FIGS. 14 to 23E.

13. The information processing device according to claim 3, which performs on-chain community detection for the users using the predetermined information included in the base information.

14. The information processing device according to claim 13, wherein the on-chain community detection is executed through wallet clustering using off-chain label information.

15. The information processing device according to claim 13, wherein the on-chain community detection is executed through similarity evaluation between wallet clusters.

16. A program that causes computers to execute token processing that automatically generates base information for tokens that can circulate on networks related to blockchain composed of multiple computers, based on various inputs from users.

17. An information processing method comprising a token processing step that automatically generates base information for tokens that can circulate on networks related to blockchain composed of multiple computers, based on various inputs from users.
